(19) United States
(12) Patent Application Publication
(10) Pub. No.: US 2024/0406907 A1
(43) Pub. Date: Dec. 5, 2024

(54) METHODS AND APPARATUS FOR DETERMINING PLMN WITH DISASTER CONDITION

(71) Applicant: SAMSUNG ELECTRONICS CO., LTD., Suwon-si, Gyeonggi-do (KR)

(72) Inventors: Aman AGARWAL, Bangalore (IN); Lalith KUMAR, Bangalore (IN); Kailash Kumar JHA, Bangalore (IN); Samiran BHOWMIK, Bangalore (IN); Mahmoud WATFA, Staines (GB)

(21) Appl. No.: 18/695,774

(22) PCT Filed: Sep. 26, 2022
(86) PCT No.: PCT/KR2022/014363

§ 371 Date: Mar. 26, 2024

(30) Foreign Application Priority Data
Sep. 28, 2021 (IN) 202141044040
Sep. 14, 2022 (IN) 202141044040

(51) Int. Cl. H04W 60/04; H04W 48/18; H04W 76/50; H04W 84/04

(52) U.S. Cl. CPC H04W 60/04; H04W 48/18; H04W 76/50; H04W 84/042

(57) ABSTRACT

The disclosure relates to a 5G or 6G communication system for supporting a higher data transmission rate. A method for determining a Public Land Mobile Network, PLMN, with disaster condition by an AMF in a wireless network is provided. The method comprises: receiving a registration request message from a UE: identifying that a 5GS registration type IE in the registration request message is set to a “disaster roaming initial registration” or a “disaster roaming mobility registration updating”; identifying whether a PLMN with disaster condition IE is included in the registration request message based on identifying that the 5GS registration type IE is set to the “disaster roaming initial registration” or the “disaster roaming mobility registration updating”; and determining a PLMN with disaster condition in the PLMN with disaster condition IE based on identifying that the PLMN with disaster condition IE is included in the registration request message.

### TECHNICAL FIELD

Embodiments disclosed herein relate to wireless communication networks and more particularly to methods and wireless communication networks for determining a Public Land Mobile Network (PLMN) with disaster situation during MINT situation.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The purpose of MINT (Minimization of Service Interruption) is to minimize interruption of service to users when a wireless communication network (aka “wireless network”) to which these users are subscribed cannot provide service due to a disaster such as, e.g., a fire, by enabling the users to obtain service on other networks, while at the same time protecting those other networks from congestion.

Consider that PLMN D is subject to disaster (i.e., PLMN-D is the PLMN with disaster condition) and the PLMN A (200a) is alive and not subject to the disaster. The PLMN-A may provide disaster roaming service to the users of the PLMN-D (i.e., to the Disaster Inbound roamers of the PLMN-D).

When the UE (100) is performing a Disaster Roaming Registration (for example—by setting or indicating the Fifth Generation System (5GS) Registration type IE to at least one of a “disaster roaming initial registration” and a “disaster roaming mobility registration updating” in the REGISTRATION REQUEST message), the UE (100) may indicate the Mobile Station (MS) determined PLMN with Disaster Condition Information Element (IE) if the UE (100) does not have valid 5G-GUTI indicating the PLMN with Disaster Condition and the PLMN with Disaster Condition is not the Home PLMN (HPLMN) of the UE (100) or the PLMN with Disaster Condition is the HPLMN of the UE (100), but the UE (100) does not provide its SUCI. For a Disaster Roaming Registration, based on the PLMN with Disaster Condition derived from the PLMN identity of the UE's 5G-GUTI, derived from the PLMN identity of the UE's SUCI or MS determined PLMN with Disaster Condition IE indicated by the UE (100) and the local configuration, the AMF determines if Disaster Roaming service can be provided. However, if the UE (100) indicates a valid 5G-GUTI or a SUCI and also indicated the MS determined PLMN with Disaster Condition IE in the Registration Request message and optionally, PLMN with disaster condition derived from the PLMN identity of the 5G-GUTI/SUCI is different from the PLMN with Disaster Condition derived from the MS determined PLMN with Disaster Condition IE indicated by the UE (100) in the Registration Request message, it is not clear how would AMF determine the PLMN with disaster condition in that case and a method needs to be defined for the same. This scenario is depicted in FIG. 1.

In an example, as shown in FIG. 1, at 101, the UE (100) detects that the disaster is happened on the PLMN D. At 102, the PLMN-A (200a) shall broadcast an indication of accessibility for disaster roaming service (optionally, PLMN-A (200a) broadcasts a “list of PLMN(s) (in an example, PLMN-D1, PLMN-D2) with Disaster condition for which Disaster Roaming is offered by the PLMN-A in the impacted area” (i.e., PLMNs with disaster condition) for which PLMN-A is providing disaster roaming services to the UE (100). At 103, the UE (100) sends the disaster roaming request (for example—by setting/indicating the Fifth Generation System (5GS) Registration type IE to at least one of a “disaster roaming initial registration” and a “disaster roaming mobility registration updating”) and the UE (100) optionally indicates 5G-GUTI or SUCI in any of the IE (for example—the 5GS mobile identity IE or the Additional GUTI IE or any of the IE) and the UE (100) indicates ‘MS determined PLMN with Disaster Condition’ IE in the Registration Request Message) to the Network or any Network Function (such as AMF) of PLMN A (200). At 104, the AMF of PLMN A (200a) may determine that the UE (100) has indicated ‘MS determined PLMN with Disaster Condition’ IE in the Registration Request Message) and optionally, the UE (100) may have indicated 5G-GUTI or SUCI in any of the IE (for example—the 5GS mobile identity IE or the Additional GUTI IE or any of the other IE). Alternatively, the AMF of PLMN A (200a) may determine that the PLMN with disaster condition derived from the PLMN identity of the 5G-GUTI or SUCI is different from the PLMN with Disaster Condition indicated in the ‘MS determined PLMN with Disaster Condition’ IE by the UE (100) in the registration request message. Alternatively, the AMF of PLMN A (200a) may determine few parameters or IE(s) indicated by the UE (100) (such as ‘MS determined PLMN with Disaster Condition’ IE, PLMN identity of the 5G-GUTI or SUCI indicated or included by the UE (100) in any IE and any other parameters or IE(s)) and there is no method defined or there is no priority defined for the AMF of PLMN A (200a) or there is no preference given by the AMF of PLMN A (200a) among the indicated or the available parameters to determine the PLMN with Disaster Condition from the indicated parameters. Hence, in the prior arts, how does the AMF of PLMN-A determine the PLMN with Disaster Condition is not clear and a method needs to be defined.

FIG. 2 depicts an example scenario in which the PLMN D is subject to disaster and PLMN A (200a) is alive and not subject to disaster and providing disaster roaming to the UE (100) for PLMN D. When the UE (100) is performing a Disaster Roaming Registration, the UE (100) may indicate the MS determined PLMN with Disaster Condition if UE (100) does not have valid 5G-GUTI indicating the PLMN with Disaster Condition and the PLMN with Disaster Condition is not the HPLMN of the UE (100) or the PLMN with Disaster Condition is the HPLMN of the UE (100), but the UE (100) does not provide its SUCI. For a Disaster Roaming Registration, based on the PLMN with Disaster Condition derived from the PLMN identity of the UE's 5G-GUTI, derived from the PLMN identity of the UE's SUCI or MS determined PLMN with Disaster Condition IE indicated by the UE (100) and the local configuration, the AMF determines if Disaster Roaming service can be provided. If the PLMN-A doesn't support disaster roaming services for the PLMN with Disaster Condition, what should be behaviour (or behavior) for AMF of PLMN-A is not clear and a method needs to be defined how can PLMN-A indicate to the UE (100) the list of PLMN(s) with Disaster Condition for which Disaster Roaming is offered by PLMN-A in the impacted area.

In other words, as shown in FIG. 2, at 201, the UE (100) determines that the disaster happened on the PLMN D. At 202, the PLMN-A (200a) shall broadcast an indication of accessibility for disaster roaming service to the UE (100). At 203. The UE (100) sends the registration request for disaster roaming to the PLMN A (200). The UE (100) indicates 5G-GUTI or SUCI in any of the IE or MS determined PLMN with Disaster Condition IE in the registration request message. At 204. PLMN-A (200a) doesn't support disaster roaming services for the PLMN with disaster condition derived from the PLMN identity of the 5G-GUTI or SUCI or MS determined PLMN with Disaster Condition IE indicated by the UE (100). In the prior arts, What shall AMF of PLMN-A do is not clear?

FIG. 3 depicts an example scenario in which the PLMN D is subject to disaster and PLMN A is alive and not subject to disaster and providing disaster roaming to the UE (100) for PLMN D. If the UE (100) supports Disaster Roaming, the UE (100) can be provisioned by the network with the “list of PLMN(s) to be used in disaster condition”, comprising of zero or more entries, each containing a PLMN ID. The PLMNs are listed in order of decreasing priority, with the first PLMN being the highest priority PLMN. The ‘list of PLMN(s) to be used in Disaster Condition’ may be pre-configured in USIM or provided by HPLMN after a successful registration procedure over 3GPP access or non-3GPP access. While roaming, the Registered PLMN may provide the ‘list of PLMN(s) to be used in disaster condition’ after a successful registration procedure to the UE (100). The UE (100) shall ignore this information if the ‘list of PLMN(s) to be used in disaster condition’ is empty. However, if the UE (100) is registered for Disaster Roaming Services on a Visited PLMN (VPLMN) i.e., on PLMN-A, it is not defined or it is not clear whether PLMN-A shall configure or provision the UE (100) with the ‘list of PLMN(s) to be used in Disaster Condition’ or not. In another embodiment, there is no method defined to stop PLMN-A from pro-visioning the UE (100) with the ‘list of PLMN(s) to be used in Disaster Condition’. Also, whether the UE (100) shall use or shall ignore the ‘list of PLMN(s) to be used in Disaster Condition’ configured by the PLMN-A is not defined and needs to be defined.

In other words, as shown in FIG. 3, at 301, the UE (100) determines that disaster happened on the PLMN D. At 302, the UE is registered on the PLMN A for disaster Roaming service for PLMN-D. At 303, shall PLMN-A configure “list of PLMN(s) to be used in disaster condition” to the UE which is registered for Disaster Roaming service is not defined and needs to be defined.

Thus, it is desired to address the above mentioned disadvantages or other shortcomings or at least provide a useful alternative.

### DISCLOSURE OF INVENTION

### Solution to Problem

The principal object of the embodiments herein is to disclose methods and wireless network for determining PLMN with disaster condition during a MINT situation, so as to ensure the service continuity without wasting resources.

According to an embodiment of the present disclosure, a method for determining a Public Land Mobile Network, PLMN, with disaster condition by an Access and Mobility Management Function, AMF, in a wireless network is provided. The method may comprise receiving a registration request message from a user equipment, UE. The method may comprise identifying that a Fifth Generation System, 5GS, registration type information element, IE, in the registration request message is set to a “disaster roaming initial registration” or a “disaster roaming mobility registration updating.” The method may comprise identifying whether a PLMN with disaster condition IE is included in the registration request message based on identifying that the 5GS registration type IE in the registration request message is set to the “disaster roaming initial registration” or the “disaster roaming mobility registration updating.” The method may comprise determining a PLMN with disaster condition in the PLMN with disaster condition IE based on identifying that the PLMN with disaster condition IE is included in the registration request message.

According to an embodiment of the present disclosure, an apparatus of an Access and Mobility Management Function, AMF, for determining a Public Land Mobile Network, PLMN, with disaster condition in a wireless network is provided. The apparatus may comprise a memory; and at least one processor coupled to the memory. The at least one processor may be configured to receive a registration request message from a user equipment, UE. The at least one processor may be configured to identify that a Fifth Generation System, 5GS, registration type information element, IE, in the registration request message is set to a “disaster roaming initial registration” or a “disaster roaming mobility registration updating.” The at least one processor may be configured to identify whether a PLMN with disaster condition IE is included in the registration request message based on identifying that the 5GS registration type IE in the registration request message is set to the “disaster roaming initial registration” or the “disaster roaming mobility registration updating.” The at least one processor may be configured to determine a PLMN with disaster condition in the PLMN with disaster condition IE based on identifying that the PLMN with disaster condition IE is included in the registration request message.

According to an embodiment of the present disclosure, a non-transitory computer readable storage medium storing instructions which, when executed by at least one processor of an apparatus of an Access and Mobility Management Function, AMF, in a wireless network, cause the apparatus perform operations, is disclosed. The operations may comprise receiving a registration request message from a user equipment, UE. The operations may comprise identifying that a Fifth Generation System, 5GS, registration type information element, IE, in the registration request message is set to a “disaster roaming initial registration” or a “disaster roaming mobility registration updating.” The operations may comprise identifying whether a PLMN with disaster condition IE is included in the registration request message based on identifying that the 5GS registration type IE in the registration request message is set to the “disaster roaming initial registration” or the “disaster roaming mobility registration updating.” The operations may comprise determining a PLMN with disaster condition in the PLMN with disaster condition IE based on identifying that the PLMN with disaster condition IE is included in the registration request message.

These and other aspects of the embodiments herein will be better appreciated and understood when considered in conjunction with the following description and the accompanying drawings. It should be understood, however, that the following de-scriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 depicts an example scenario in which PLMN D is subject to disaster and PLMN A is alive and not subject to disaster and providing disaster roaming to the UE for PLMN D, where it is not clear as to how the AMF of PLMN-A determines the PLMN with disaster condition, according to prior arts;

FIG. 2 depicts example scenario in which the PLMN D is subject to disaster and PLMN A is alive and not subject to disaster and providing disaster roaming to the UE for PLMN D, according to prior arts;

FIG. 3 depicts example scenario in which PLMN D is subject to disaster and PLMN is alive and not subject to disaster and providing disaster roaming to the UE for PLMN D, according to prior arts;

FIGS. 4A and 4B depict example scenarios in which an AMF of PLMN-A determines the PLMN with disaster condition, according to embodiments as disclosed herein;

FIGS. 5A and 5B depict example scenario in which the PLMN D is subject to disaster and PLMN A is alive and not subject to disaster and providing disaster roaming to the UE for PLMN D, according to embodiments as disclosed herein;

FIG. 6 depicts example scenario in which PLMN D is subject to disaster and PLMN is alive and not subject to disaster and providing disaster roaming to the UE for PLMN D, according to embodiments as disclosed herein;

FIG. 7 shows various hardware components of a AMF (aka “AMF entity”), according to the embodiments as disclosed herein; and

FIG. 8, FIG. 9, FIG. 10, FIG. 11 are flow charts illustrating methods for determining the PLMN with the disaster situation in the wireless network, according to the embodiments as disclosed herein.

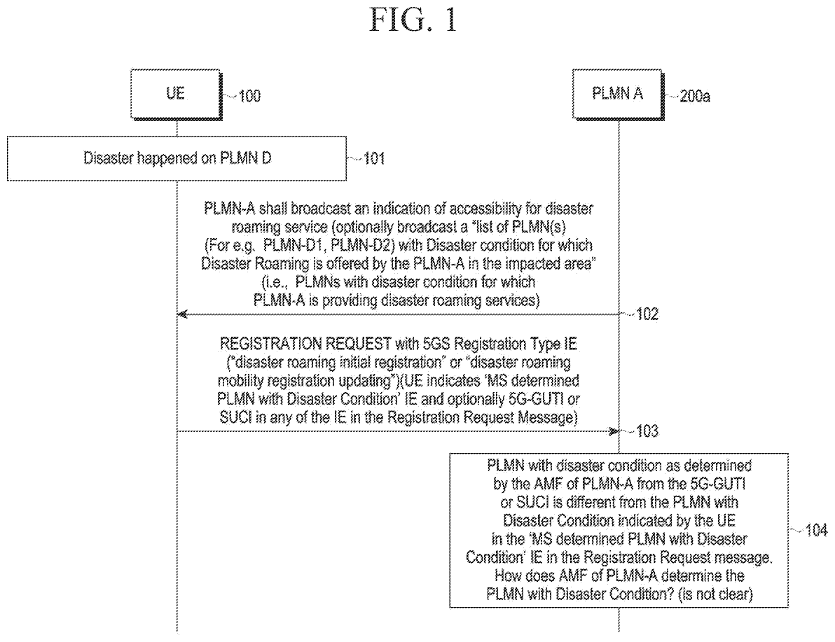

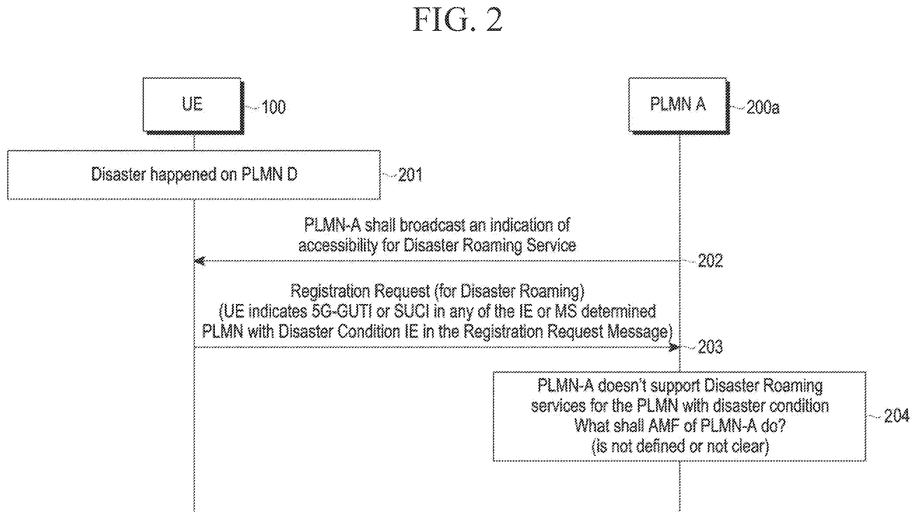

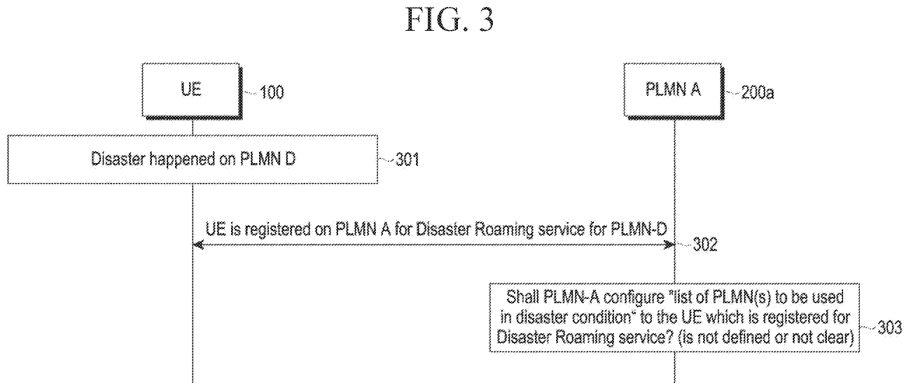

### MODE FOR THE INVENTION

The embodiments herein and the various features and advantageous details thereof are explained more fully with reference to the non-limiting embodiments that are illustrated in the accompanying drawings and detailed in the following description. De-scriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve methods for determining a PLMN with disaster situation in a wireless network. The method includes determining, by an AMF entity, whether a Mobile Station (MS) determined PLMN with disaster condition information element (IE) is included in a registration request message. In an embodiment, upon determining that the MS determined PLMN with disaster condition IE has been included in the registration request message, the method includes determining, by an AMF entity, that the MS determined PLMN with disaster condition IE is a “PLMN with disaster condition” for which a UE is requesting at least one disaster roaming service, determining whether the at least one disaster roaming service need to be provided to the UE for the “PLMN with disaster condition”, and ignoring a PLMN with disaster condition derived from a PLMN identity of one of a fifth generation-Globally Unique Temporary Identifier (5G-GUTI) or a Subscription Concealed Identifier (SUCI), if the 5G-GUTI or the SUCI is included in any of the IE (for example—the 5GS mobile identity IE or the Additional GUTI IE or any of the other IE) in the registration request message. In an embodiment, upon determining, by the AMF entity, that the MS determined PLMN with disaster condition IE has been included in the registration request message, the method includes the AMF entity to give preference or to prioritize the indicated MS determined PLMN with disaster condition IE over any other parameters or IE (for example-5G-GUTI or SUCI), if included, to determine the “PLMN with disaster condition” for which a User Equipment (UE) is requesting at least one disaster roaming service. In another embodiment, upon determining that the MS determined PLMN with disaster condition IE has not been included in the registration request message, the method includes determining a PLMN with disaster condition obtained from the PLMN identity of one of the 5G-GUTI or the SUCI, if the 5G-GUTI or the SUCI is included in any of the IE in the registration request message and is valid.

In an embodiment, if a 5GS registration type IE in the REGISTRATION REQUEST message is set to “disaster roaming initial registration” and the MS determined PLMN with disaster condition IE is included in the REGISTRATION REQUEST message, the AMF shall determine the PLMN with disaster condition in the MS determined PLMN with disaster condition IE.

In another embodiment, if the 5GS registration type IE is set to “disaster roaming mobility registration updating” and the MS determined PLMN with disaster condition IE is included in the REGISTRATION REQUEST message, the AMF shall determine the PLMN with disaster condition in the MS determined PLMN with disaster condition IE.

The proposed method ensures a service continuity without wasting resources.

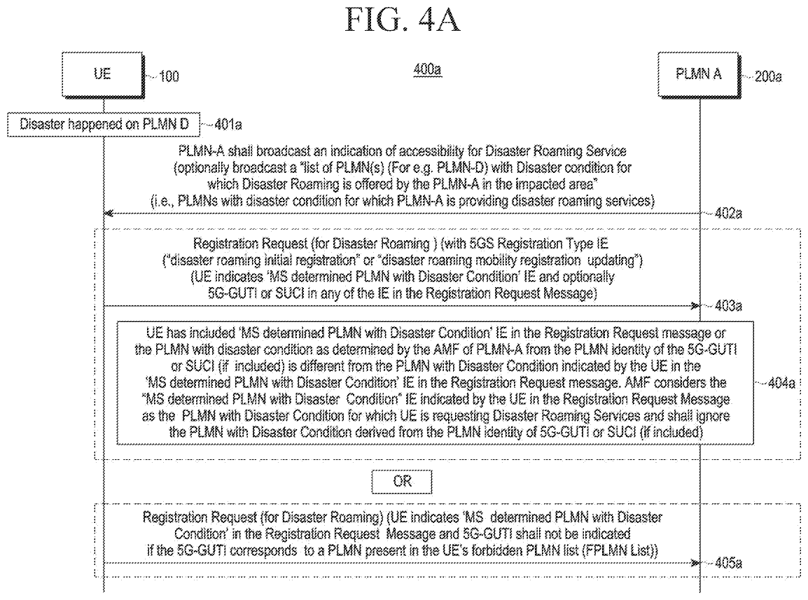

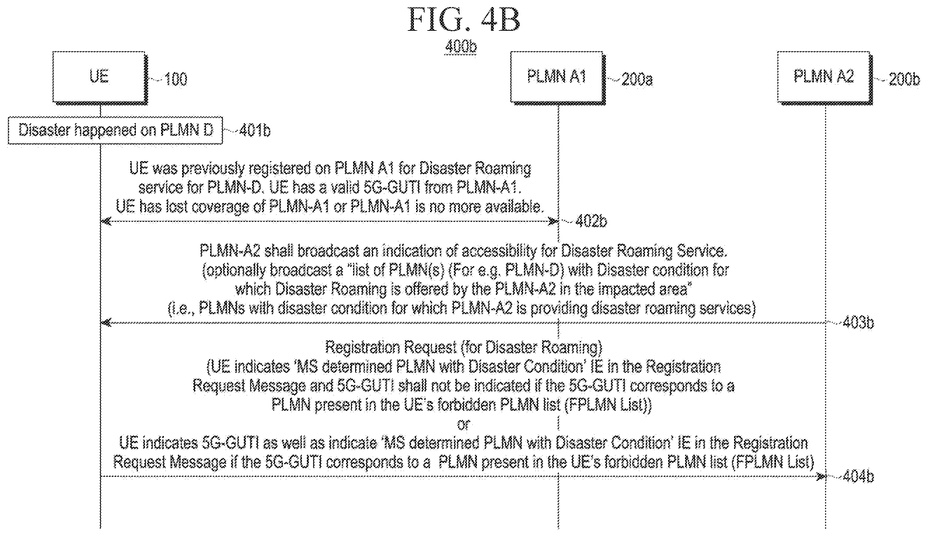

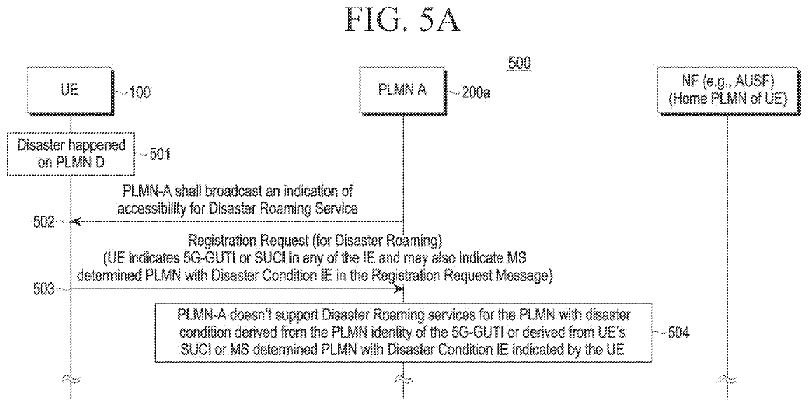

Referring now to the drawings, and more particularly to FIGS. 4A through 11, where similar reference characters denote corresponding features consistently throughout the figures, there are shown at least one embodiment.

The following abbreviations have been used herein in the patent disclosure:
a) 4G-GUTI-4G-Globally Unique Temporary Identifier
b) 5G-GUTI-5G-Globally Unique Temporary Identifier
c) 5GMM-5GS Mobility Management
d) 5GS-5G System
c) 5GSM-5GS Session Management
f) 5G-S-TMSI-5G S-Temporary Mobile Subscription Identifier
g) 5G-TMSI-5G Temporary Mobile Subscription Identifier
h) AMF-Access and Mobility Management Function
i) AUSF-Authentication Server Function
j) NF-Network Function
k) SUCI-Subscription Concealed Identifier
l) CAG-Closed access group
m) PLMN-Public Land Mobile Network
n) MS-Mobile Station
o) UE-User Equipment
p) ME-Mobile Equipment
q) USIM-Universal Subscriber Identity Module
r) UDM-Unified Data Management Function
s) SIM-Subscriber Identity Module
t) VPLMN-Visited PLMN
u) HPLMN-Home PLMN
v) MINT-Minimization of service interruption

The following terms have been used herein in the patent disclosure:
1. Allowable PLMN: In the case of an MS operating in MS operation mode A or B, this is a PLMN which is not in the list of “forbidden PLMNs” in the MS. In the case of an MS operating in MS operation mode C or an MS not supporting A/Gb mode and not supporting Iu mode, this is a PLMN which is not in the list of “forbidden PLMNs” and not in the list of “forbidden PLMNs for GPRS service” in the MS.
2. Available PLMN: For GERAN A/Gb mode see 3GPP TS 43.022. For UTRAN, see 3GPP TS 25.304. For E-UTRAN, see 3GPP TS 36.304. For NG-RAN, see 3GPP TS 36.304 and 3GPP TS 38.304. For cdma2000® 1×RTT and cdma2000® HRPD, see 3GPP2 C.S0016.
3. Camped on a cell: The MS (ME if there is no SIM) has completed the cell selection/reselection process and has chosen a cell from which it plans to receive all available services. Note that the services may be limited, and that the PLMN or the SNPN may not be aware of the existence of the MS (ME) within the chosen cell.
4. EHPLMN: Any of the PLMN entries contained in the Equivalent HPLMN list.
5. Equivalent HPLMN list: To allow provision for multiple HPLMN codes, PLMN codes that are present within this list shall replace the HPLMN code derived from the IMSI for PLMN selection purposes. This list is stored on the USIM and is known as the EHPLMN list. The EHPLMN list may also contain the HPLMN code derived from the IMSI. If the HPLMN code derived from the IMSI is not present in the EHPLMN list then it shall be treated as a Visited PLMN for PLMN selection purposes.
6. High quality signal: The high quality signal limit is used in the PLMN selection procedure. It is defined in the appropriate AS specification: 3GPP TS 43.022 for the GSM radio access technology, 3GPP TS 25.304 for the UMTS radio access technology (FDD or TDD mode), 3GPP TS 36.304 for the E UTRAN radio access technology (WB-S1 mode, NB-S1 mode, WB-N1 mode or NB-N1 mode), 3GPP TS 36.304 and 3GPP TS 38.304 for the NG-RAN radio access technology. For 3GPP2 access technologies the high quality signal limit is defined in 3GPP2 C.S0011 for cdma2000® 1×RTT and in 3GPP2 C.S0033 for cdma2000® HRPD. A mobile station attempting to find a cell that supports EC-GSM-IoT (see 3GPP TS 43.064) does not use high quality signal limit in the PLMN selection procedure, i.e., for the purpose of PLMN selection, when attempting to find a cell that supports EC-GSM-IoT, any found cell supporting EC-GSM-IoT is considered to be received with high quality signal. A UE attempting to find a cell that supports enhanced coverage when operating in any WB-S1 or WB-N1 enhanced coverage mode does not use high quality signal limit in the PLMN selection procedure, i.e. for the purpose of PLMN selection, when attempting to find a cell that supports enhanced coverage, any found cell supporting enhanced coverage and satisfying the coverage specific quality signal limit defined for CE mode (see 3GPP TS 36.304) is considered to be received with high quality signal.
7. Home PLMN: This is a PLMN where the MCC and MNC of the PLMN identity match the MCC and MNC of the IMSI.
8. Registered PLMN (RPLMN): This is the PLMN on which certain LR outcomes have occurred. In a shared network the RPLMN is the PLMN defined by the PLMN identity of the CN operator that has accepted the LR.
9. Registration: This is the process of camping on a cell of the PLMN or the SNPN and doing any necessary LRs.
10. UPLMN: PLMN/access technology combination in the “User Controlled PLMN Selector with Access Technology” data file in the SIM (in priority order).
11. OPLMN: PLMN/access technology combination in the “Operator Controlled PLMN Selector with Access Technology” data file in the SIM (in priority order) or stored in the ME (in priority order).
12. Visited PLMN (VPLMN): This is a PLMN different from the HPLMN (if the EHPLMN list is not present or is empty) or different from an EHPLMN (if the EHPLMN list is present).
13. Disaster Condition: This is the condition that a government decides when to initiate and terminate, e.g. a natural disaster. When this condition applies, users may have the opportunity to mitigate service interruptions and failures.
14. Disaster Inbound Roamer: A user that (a) cannot get service from the PLMN it would normally be served by, due to failure of service during a Disaster Condition, and (b) is able to register with other PLMNs.
15. Disaster Roaming: This is the special roaming policy that applies during a Disaster Condition.
16. PLMN with Disaster Condition: A PLMN to which a Disaster Condition applies.
17. Registered for disaster roaming services: A UE is considered as “registered for disaster roaming services” when it has successfully completed initial registration or mobility registration for disaster roaming services.

Disaster Condition is a condition that a government decides when to initiate and terminate, e.g., a natural disaster. When this condition applies, users may have the opportunity to mitigate service interruptions and failures.

Disaster Inbound Roamer is a user that (a) cannot get service from the PLMN it would normally be served by, due to failure of service during a disaster condition, and/or (b) is able to register with other PLMNs.

Disaster Roaming is the special roaming policy that applies during a disaster condition.

The PLMN with disaster condition is a PLMN to which a disaster condition applies. In the description, PLMN D or PLMN-D is subject to disaster (i.e., PLMN-D is the PLMN with disaster condition) and PLMN A or PLMN-A is alive and not subject to disaster. PLMN-A may provide disaster roaming service to the users of the PLMN-D (i.e. to the Disaster Inbound roamers of the PLMN-D)

The terms disaster based service, disaster roaming service and disaster inbound roaming are used interchangeably in this embodiment and have the same meaning.

The terms disaster situation and disaster condition are used interchangeably in this embodiment and have the same meaning.

The terms PLMN D and PLMN-D are used interchangeably in this embodiment and have the same meaning.

The terms PLMN A and PLMN-A are used interchangeably in this embodiment and have the same meaning.

The terms UE and MS are used interchangeably in this embodiment and have the same meaning.

The terms “PLMN with disaster condition IE”, “MS determined PLMN with disaster condition IE” and “PLMN with disaster situation IE” are used interchangeably in this embodiment and have the same meaning.

The term or method where “UE is registering or registered for the disaster roaming service” may refer to a situation or condition, but not restricted or limited to, where UE sets or indicates the Fifth Generation System (5GS) Registration type IE to at least one of a “disaster roaming initial registration” and a “disaster roaming mobility registration updating” in the REGISTRATION REQUEST message.

The terms or methods “the PLMN with disaster condition derived from the PLMN identity of the 5G-GUTI or SUCI” and “the PLMN with disaster condition derived from the 5G-GUTI or SUCI” are used interchangeably in this embodiment and have the same meaning.

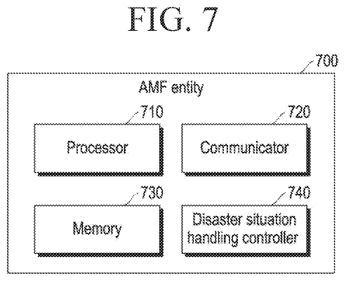

FIGS. 4A and 4B depict an example scenario in which a AMF (700) (as shown in FIG. 7) of PLMN-A determines the PLMN with disaster condition. FIG. 4A depicts an example scenario in which PLMN D is subject to disaster and PLMN A (200a) is alive and not subject to disaster and providing disaster roaming to the UE (100) for PLMN D.

FIG. 4B depicts an example scenario in which PLMN D is subject to disaster and PLMN A(s) (200a and 200b) (PLMN-A1, PLMN-A2) are alive and not subject to disaster and providing disaster roaming to the UE (100) for PLMN D.

When the UE (100) is performing a Disaster Roaming Registration (for example—by setting/indicating the Fifth Generation System (5GS) Registration type IE to at least one of a “disaster roaming initial registration” and a “disaster roaming mobility registration updating”), the UE (100) may indicate the Mobile Station (MS) determined PLMN with Disaster Condition IE if UE (100) does not have valid 5G-GUTI indicating the PLMN with Disaster Condition and the PLMN with Disaster Condition is not the Home PLMN (HPLMN) of the UE (100) or the PLMN with Disaster Condition is the HPLMN of the UE (100) but the UE (100) does not provide its SUCI or 5G-GUTI. For the Disaster Roaming Registration, based on the PLMN with Disaster Condition derived from the UE's 5G-GUTI, derived from the UE's SUCI or MS determined PLMN with Disaster Condition IE indicated by the UE (100) (for e.g., PLMN-D) and the local configuration, the AMF determines if Disaster Roaming service can be provided. However, if the UE (100) indicates a valid 5G-GUTI or a SUCI and the MS determined PLMN with Disaster Condition IE in the Registration Request message and PLMN with disaster condition derived from the 5G-GUTI or SUCI is different from the MS determined PLMN with Disaster Condition IE indicated by the UE (100) in the Registration Request message, then the AMF of PLMN-A shall consider the “MS determined PLMN with Disaster Condition” IE indicated by the UE (100) in the Registration Request message as the PLMN with Disaster Condition for which UE (100) is requesting Disaster Roaming Services and shall ignore the PLMN with Disaster Condition derived from the PLMN Identity of the 5G-GUTI or the SUCI. In another embodiment, if the UE (100) is performing a Disaster Roaming Registration (for example—by setting/indicating the Fifth Generation System (5GS) Registration type IE to at least one of a “disaster roaming initial registration” and a “disaster roaming mobility registration updating”) and if the MS determined PLMN with Disaster Condition IE is indicated by the UE (100) in the Registration Request message, then the AMF of the PLMN-A (200a) shall consider the “MS determined PLMN with Disaster Condition” IE indicated by the UE (100) in the Registration Request message as the PLMN with Disaster Condition for which UE (100) is requesting Disaster Roaming Services and optionally, shall ignore the PLMN with Disaster Condition derived from the PLMN Identity of the 5G-GUTI or the SUCI, if the 5G-GUTI or the SUCI is included in any of the IE in the registration request message and is valid.

In an embodiment, when the UE (100) is performing the disaster roaming registration and if the 5G-GUTI present in the UE (100) corresponds a PLMN present in the UE's forbidden PLMN list (FPLMN List), the UE (100) shall not include 5G-GUTI in the registration request message for disaster roaming services. Alternatively, the UE (100) shall include 5G-GUTI as well as indicate “MS determined PLMN with Disaster Condition” IE (for e.g., PLMN-D) in the Registration Request message for Disaster Roaming services. In that case, the UE (100) shall either include SUCI if the PLMN with Disaster Condition is the HPLMN or UE (100) shall include “MS determined PLMN with Disaster Condition” (for e.g., PLMN-D) if the PLMN with Disaster Condition is not the HPLMN of the UE (100) or the PLMN with Disaster Condition is the HPLMN of the UE (100) but the UE (100) does not provide its SUCI. Alternatively, UE (100) shall include 5G-GUTI or SUCI and shall include “MS determined PLMN with Disaster Condition” (for e.g., PLMN-D) in the Registration Request message if the 5G-GUTI present in the UE (100) corresponds a PLMN present in the UE's forbidden PLMN list (FPLMN List). In that case, AMF of the PLMN-A (i.e. The PLMN providing the disaster roaming service to the UE (100) on behalf of the PLMN-D) shall either determine the PLMN with Disaster Condition from the SUCI (if indicated by the UE) or shall consider the “MS determined PLMN with Disaster Condition” indicated by the UE (100) in the Registration Request message as the PLMN with Disaster Condition for which UE (100) is requesting Disaster Roaming Services and shall ignore the PLMN with Disaster Condition derived from the PLMN identity of the 5G-GUTI indicated by the UE (100). The AMF of PLMN-A shall consider the “MS determined PLMN with Disaster Condition” if indicated by the UE (100) in the Registration Request message as the PLMN with Disaster Condition for which UE is requesting Disaster Roaming Services and shall ignore the PLMN with Disaster Condition derived from the PLMN identity of the 5G-GUTI or SUCI. This is done to avoid PLMN-A from assuming that UE (100) is requesting disaster roaming service for a PLMN derived from PLMN identity of the 5G-GUTI which might belong to UE's forbidden PLMN list.

When the UE (100) is moving from PLMN-A1 to PLMN-A2, and the UE (100) is performing a Disaster Roaming Registration, the UE (100) shall not include 5G-GUTI and shall include “MS determined PLMN with Disaster Condition” (for e.g., PLMN-D) in the Registration Request message. Alternatively, the UE (100) shall include 5G-GUTI or SUCI as well as indicate “MS determined PLMN with Disaster Condition” (for e.g., PLMN-D) in the Registration Request message. PLMN-A2 shall consider the “MS determined PLMN with Disaster Condition” indicated by the UE (100) in the Registration Request message as the PLMN with Disaster Condition for which UE (100) is requesting Disaster Roaming Services and shall ignore the PLMN with Disaster Condition derived from the PLMN identity of the 5G-GUTI or SUCI.

As shown in FIG. 4A, at 401a, the UE (100) determines that the disaster happened on the PLMN D. At 402a, the PLMN-A (200a) shall broadcast an indication of accessibility for disaster roaming service. The PLMN-A (200a) optionally broadcast a “list of PLMN(s) (In an example, the PLMN-D with Disaster condition for which Disaster Roaming is offered by the PLMN-A in the impacted area” (i.e., PLMNs with disaster condition) for which PLMN-A is providing disaster roaming services. In an embodiment, at 403a, the UE (100) sends the registration request (for disaster roaming) to the PLMN A (200a). The UE (100) indicates 5G-GUTI or SUCI and ‘MS determined PLMN with Disaster Condition’ in the registration request message. At 404a, the PLMN with disaster condition derived from the PLMN identity 5G-GUTI or SUCI is different from the PLMN with disaster condition indicated in the ‘MS determined PLMN with Disaster Condition’ IE by the UE (100) in the registration request message. In another embodiment, the UE (100) indicates ‘MS determined PLMN with Disaster Condition’ in the registration request message and may optionally, include or indicate the 5G-GUTI or SUCI in any of the IE in the registration request message. The AMF considers the “MS determined PLMN with Disaster Condition” indicated by the UE (100) in the registration request message as the PLMN with Disaster Condition for which the UE (100) is requesting Disaster Roaming Services and shall, optionally, ignore the PLMN with Disaster Condition derived from the 5G-GUTI or SUCI. Alternatively, at 405a. The UE (100) sends the registration request (for disaster roaming) to the PLMN A. The UE (100) indicates ‘MS determined PLMN with Disaster Condition’ in the Registration Request Message and 5G-GUTI shall not be indicated if the 5G-GUTI corresponds to a PLMN present in the UE's forbidden PLMN list (FPLMN List).

As shown in FIG. 4b, at 401b, the UE (100) detects that the disaster happened on the PLMN D. At 402b, the UE (100) was previously registered on the PLMN A1 for Disaster Roaming service for PLMN-D. The UE (100) has a valid 5G-GUTI from the PLMN-A1. The UE (100) has lost coverage of PLMN-A1 or PLMN-A1 is no more available. At 403b, the PLMN-A2 shall broadcast an indication of accessibility for Disaster Roaming Service. The PLMN-A2 optionally broadcasts a “list of PLMN(s) with Disaster condition for which Disaster Roaming is offered by the PLMN-A2 in the impacted area” (i.e., PLMNs with disaster condition) for which PLMN-A2 is providing disaster roaming services. At 404b, in an embodiment, the UE (100) sends the registration request (for disaster roaming) to the PLMN A2. The UE (100) indicates ‘MS determined PLMN with Disaster Condition’ in the Registration Request Message and 5G-GUTI shall not be indicated if the 5G-GUTI corresponds to a PLMN present in the UE's forbidden PLMN list (FPLMN List). In another embodiment, the UE (100) indicates 5G-GUTI as well as indicate ‘MS determined PLMN with Disaster Condition’ in the Registration Request Message if the 5G-GUTI corresponds to a PLMN present in the UE's forbidden PLMN list (i.e., FPLMN List).

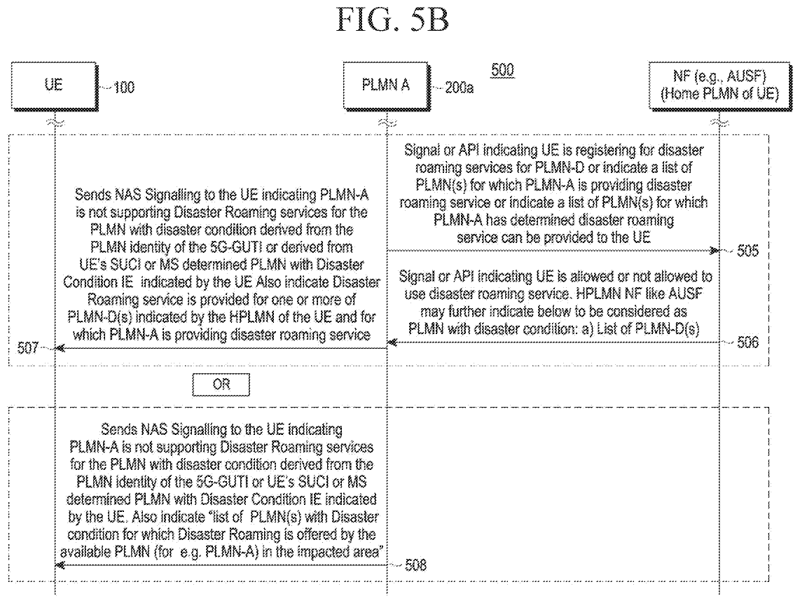

FIGS. 5A and 5B depict a scenario, wherein the PLMN D is subject to disaster and PLMN A (200a) is alive and not subject to disaster and providing disaster roaming to the UE (100) for PLMN D. When the UE (100) is performing a Disaster Roaming Registration, the UE (100) may indicate the MS determined PLMN with Disaster Condition if the UE (100) does not have valid 5G-GUTI indicating the PLMN with Disaster Condition and the PLMN with Disaster Condition is not the HPLMN of the UE (100) or the PLMN with Disaster Condition is the HPLMN of the UE (100) but the UE (100) does not provide its SUCI or the 5G-GUTI.

For the disaster roaming registration, based on the PLMN with Disaster Condition derived from the UE's 5G-GUTI, derived from the UE's SUCI or MS determined PLMN with Disaster Condition IE indicated by the UE (100) and the local configuration, the AMF determines if Disaster Roaming service can be provided.

The AMF of PLMN-A shall check and shall determine UE's PLMN with Disaster Condition derived from the 5G-GUTI, derived from the UE's SUCI or MS determined PLMN with Disaster Condition IE indicated by the UE (100) in the Registration Request Message. If the PLMN-A doesn't support Disaster Roaming services for the PLMN with Disaster Condition derived from the 5G-GUTI, derived from the UE's SUCI or MS determined PLMN with Disaster Condition IE indicated by the UE (100), then:

a) PLMN-A shall trigger a NAS signalling message to the UE (100) indicating that Disaster Roaming services are not supported for the PLMN with Disaster Condition derived from the 5G-GUTI or derived from the UE's SUCI or MS determined PLMN with Disaster Condition IE indicated by the UE (100). PLMN-A shall additionally indicate in this message the “list of PLMN(s) with Disaster condition for which Disaster Roaming is offered by the available PLMN (for e.g. PLMN-A) in the impacted area”.

b) The AMF of PLMN-A shall initiate a signal or trigger an API towards the Home PLMN (HPLMN) Network function (NF) like AUSF, UDM, PCF etc and indicate that UE (100) is registering for disaster roaming service and indicate that PLMN-A is not supporting Disaster Roaming services for the PLMN with disaster condition derived from the 5G-GUTI or derived from the UE's SUCI or MS determined PLMN with Disaster Condition IE indicated by the UE (100). In yet another embodiment, the AMF of PLMN-A may also indicate a list of PLMN(s) for which PLMN-A is providing disaster roaming service or has determined to provide disaster roaming service for this UE (100) while triggering signal towards the NF of the Home PLMN of the UE (100).

Any HPLMN NF will signal to VPLMN NF like AMF one or more PLMN-D(s) for which UE (100) is allowed to use Disaster roaming service. The one or more PLMN-D(s) indicated by the HPLMN NF can either be selected by the HPLMN independently or it can based on the list of PLMN(s) provided by the NF (for e.g., AMF) of the PLMN-A for which PLMN-A is providing disaster roaming service.

The AMF of PLMN-A shall select one of the PLMN-D(s) indicated by the HPLMN of the UE (100) and for which PLMN-A is providing disaster roaming service and shall send a NAS Signalling message to the UE (100) indicating that the disaster roaming service is provided for the selected PLMN-D and PLMN-A is not supporting Disaster Roaming services for the PLMN with disaster condition derived from the 5G-GUTI or derived from the UE's SUCI or MS determined PLMN with Disaster Condition IE indicated by the UE (100). Alternatively, AMF of PLMN-A shall indicate to the UE (100) in a NAS Signalling message that PLMN-A is not supporting Disaster Roaming services for the PLMN with disaster condition derived from the 5G-GUTI or derived from the UE's SUCI or MS determined PLMN with Disaster Condition IE indicated by the UE (100) and indicate the list of those PLMN-D(s) among the PLMN-D(s) shared the HPLMN NF of the UE (100) to the AMF of the PLMN-A for which PLMN-A is providing disaster roaming service.

In an embodiment, the AMF derives PLMN-D from the GUTI is used in the ex-planation but the solutions are also applicable for the case when the UE (100) indicates the PLMN-D using SUCI or dedicated IE to indicate the PLMN-D.

At 501, the UE (100) determines that the disaster happened on the PLMN D. At 502, the PLMN-A (200a) shall broadcast the indication of accessibility for the disaster roaming service. At 503, the UE (100) sends the registration request (for disaster roaming) to the PLMN A. The UE (100) indicates the 5G-GUTI or SUCI in any IE and may also indicate MS determined PLMN with Disaster Condition in the registration request message. At 504, the PLMN-A (200a) doesn't support Disaster Roaming services for the PLMN with disaster condition derived from the PLMN identity of the 5G-GUTI or derived from UE's SUCI or MS determined PLMN with Disaster Condition IE indicated by the UE (100).

In an embodiment, at 505, the PLMN A sends the signal or API indicating the UE (100) is registering for disaster roaming services for the PLMN-D or indicate a list of PLMN(s) for which PLMN-A is providing disaster roaming service or indicate a list of PLMN(s) for which PLMN-A has determined disaster roaming service can be provided to the UE (100). At 506, the NF (e.g., AUSF or the like) sends the signal or API indicating UE is allowed or not allowed to use disaster roaming service. The NF may further indicate to be considered as PLMN with disaster condition such as List of PLMN-D(s). At 507, the PLMN A (200) sends the NAS signalling to the UE (100) indicating PLMN-A is not supporting Disaster Roaming services for the PLMN with disaster condition derived from the PLMN identity of the 5G-GUTI or derived from UE's SUCI or MS determined PLMN with Disaster Condition IE indicated by the UE (100). Also indicating the disaster roaming service is provided for one or more of PLMN-D(s) indicated by the HPLMN of the UE and for which PLMN-A is providing disaster roaming service

In another embodiment, at 508, the PLMN A (200a) sends the NAS Signalling to the UE (100) indicating the PLMN-A is not supporting disaster roaming services for the PLMN with disaster condition derived from the 5G-GUTI or UE's SUCI or MS determined PLMN with Disaster Condition IE indicated by the UE (100). Also, the PLMN A (200a) indicate “list of PLMN(s) with disaster condition for which disaster roaming is offered by the available PLMN (for e.g. PLMN-A) in the impacted area.

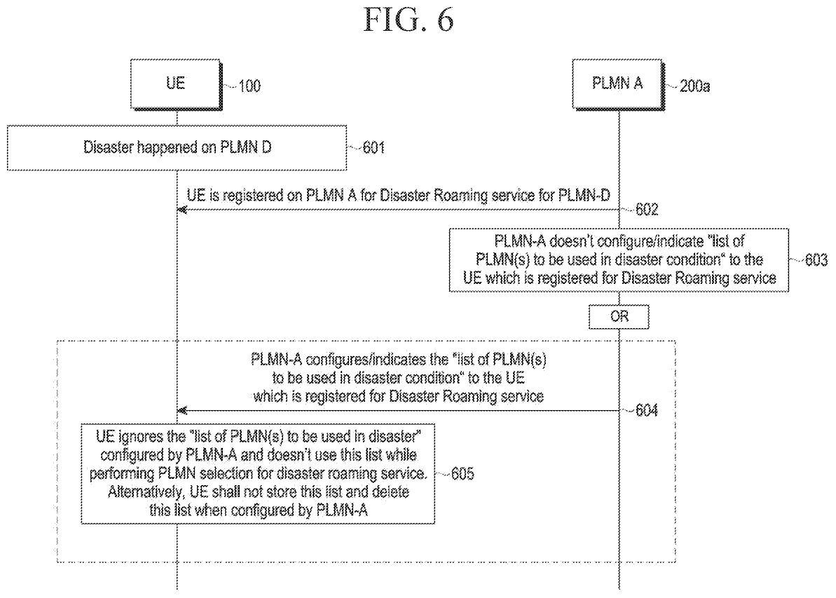

FIG. 6 depicts an example scenario in which PLMN D is subject to disaster and PLMN is alive and not subject to disaster and providing disaster roaming to the UE (100) for PLMN D. If the UE (100) supports Disaster Roaming, the UE (100) can be provisioned by the network with the “list of PLMN(s) to be used in disaster condition”, comprising of zero or more entries, each containing a PLMN ID. The PLMNs are listed in order of decreasing priority, with the first PLMN being the highest priority PLMN. The ‘list of PLMN(s) to be used in Disaster Condition’ may be pre-configured in USIM or provided by HPLMN after a successful registration procedure over 3GPP access or non-3GPP access. While roaming, the Registered PLMN may provide the ‘list of PLMN(s) to be used in disaster condition’ after a successful registration procedure to the UE, only if the UE (100) is not registered for Disaster Roaming services. While roaming, the Registered PLMN shall not provide the ‘list of PLMN(s) to be used in disaster condition’ after a successful registration procedure to the UE (100) if the UE (100) is registered for Disaster Roaming services. The UE (100) shall ignore this information if the ‘list of PLMN(s) to be used in disaster condition’ is empty. If the UE (100) is registered for Disaster Roaming Services on a Visited PLMN (VPLMN), i.e., on PLMN-A, then PLMN-A shall not configure or indicate to any UE (100) registered for disaster roaming service the “list of PLMN(s) to be used in disaster condition” at 602 and 603.

In yet another embodiment, at 604 and 605, if the PLMN-A configures or indicates to the UE (100) the “list of PLMN(s) to be used in disaster condition” while the UE is registered for disaster roaming service UE (100) shall ignore this list and shall not use this list while performing PLMN Selection for disaster roaming services. Alternatively, the UE (100) can delete this list and not store this list when received or indicated from PLMN-A.

FIG. 7 shows various hardware components of the AMF (aka “AMF entity”) (700), according to the embodiments as disclosed herein. In an embodiment, the AMF entity (700) includes a processor (710), a communicator (720), a memory (730) and a disaster situation handling controller (740). The processor (710) is coupled with the communicator (720), the memory (730) and the disaster situation handling controller (740). The disaster situation handling controller (740) determines whether the UE (100) is registering for Disaster Roaming services (for example—whether the UE (100) sets Fifth Generation System (5GS) Registration type IE to at least one of a “disaster roaming initial registration” and a “disaster roaming mobility registration updating” in the REGISTRATION REQUEST message). The disaster situation handling controller (740) also determines whether the MS Determined PLMN with disaster condition IE is included in the registration request message. In an embodiment, upon determining that the UE is registering for disaster roaming services and MS determined PLMN with disaster condition IE has been included in the registration request message, the disaster situation handling controller (740) determines that the MS determined PLMN with disaster condition IE is the “PLMN with disaster condition” for which the UE (100) is requesting at least one disaster roaming service. Further, the disaster situation handling controller (740) determines whether the at least one disaster roaming service need to be provided to the UE (100) for the “PLMN with disaster condition”. Further, the disaster situation handling controller (740), optionally, ignores the PLMN with disaster condition derived from the PLMN identity of one of the 5G-GUTI or the SUCI, if the 5G-GUTI or the SUCI is included in any of the IE in the registration request message. In another embodiment, upon determining that the MS determined PLMN with disaster condition IE has not been included in the registration request message, the disaster situation handling controller (740) determines the PLMN with disaster condition obtained from the PLMN identity of one of the 5G-GUTI or the SUCI, if the 5G-GUTI or the SUCI is included in any of the IE in the registration request message and is valid.

In another embodiment, the disaster situation handling controller (740) receives the registration request message comprising the MS determined PLMN with disaster condition IE and optionally, at least one of the 5G-GUTI and the SUCI. Further, the disaster situation handling controller (740) determines that the “PLMN with disaster condition” derived from the PLMN identity of at least one of the 5G-GUTI and the SUCI is different from the “PLMN with disaster condition” indicated by the MS determined PLMN with disaster condition IE in the registration request message. Further, the disaster situation handling controller (740) considers the “PLMN with disaster condition” indicated by the MS determined PLMN with disaster condition IE as the PLMN with disaster condition for which the UE (100) is requesting at least one disaster roaming service and optionally, ignore the PLMN with disaster condition derived from PLMN identity of at least one of the 5G-GUTI and the SUCI, if the 5G-GUTI or the SUCI is included in any of the IE in the registration request message and is valid based on the determination.

In another embodiment, the disaster situation handling controller (740) determines that at least one disaster roaming service is not supported for the PLMN with disaster condition obtained from the at least one parameter. The at least one parameter comprises the PLMN identity of the 5G-GUTI or the PLMN with disaster condition derived from the PLMN identity of the SUCI or the PLMN with disaster condition indicated by the UE (100). Further, the disaster situation handling controller (740) triggers a NAS signalling message to the UE (100). The NAS signalling message indicates that the at least one disaster roaming service is not supported for the PLMN with disaster condition obtained from the at least one parameter. Further, the disaster situation handling controller (740) provide the list of PLMNs with disaster condition for which a disaster roaming is offered by a selected PLMN in a disaster area.

In another embodiment, the disaster situation handling controller (740) determines that the MS determined PLMN with disaster condition IE is included in the registration request message upon determining one of the 5GS registration type IE in the registration request message is set to the “disaster roaming initial registration” or the 5GS registration type IE is set to the “disaster roaming mobility registration updating”. In response to determining that the MS determined PLMN with disaster condition IE has been included in the registration request message, the disaster situation handling controller (740) determines the PLMN with disaster condition in the MS determined PLMN with disaster condition IE.

The disaster situation handling controller (740) is physically implemented by analog and/or digital circuits such as logic gates, integrated circuits, microprocessors, micro-controllers, memory circuits, passive electronic components, active electronic components, optical components, hardwired circuits and the like, and may optionally be driven by firmware. The disaster situation handling controller (740) and the processor (710) may be integrally referred to as at least one processor.

Further, the processor (710) is configured to execute instructions stored in the memory (730) and to perform various processes. The communicator (720) is configured for communicating internally between internal hardware components and with external devices via one or more networks. The memory (730) also stores instructions to be executed by the processor (710). The memory (730) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (730) may, in some examples, be considered a non-transitory storage medium. The term “non-transitory” may indicate that the storage medium is not embodied in a carrier wave or a propagated signal. However, the term “non-transitory” should not be interpreted that the memory (730) is non-movable. In certain examples, a non-transitory storage medium may store data that can, over time, change (e.g., in Random Access Memory (RAM) or cache).

Although the FIG. 7 shows various hardware components of the AMF entity (700) but it is to be understood that other embodiments are not limited thereon. In other embodiments, the AMF entity (700) may include less or more number of components. Further, the labels or names of the components are used only for illustrative purpose and does not limit the scope of the invention. One or more components can be combined together to perform same or substantially similar function in the AMF entity (700).

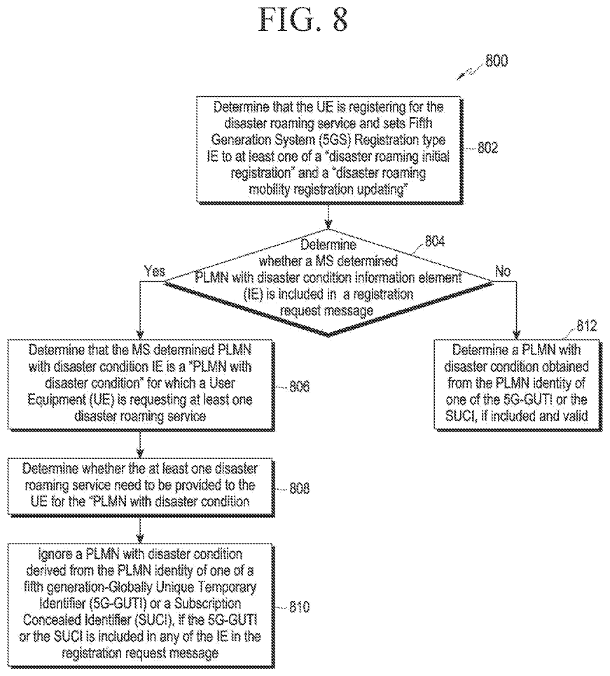

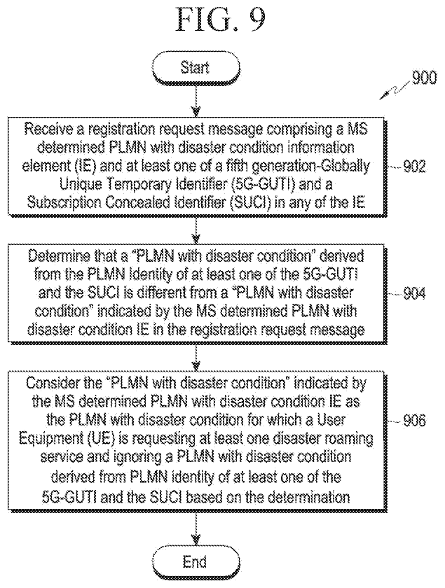

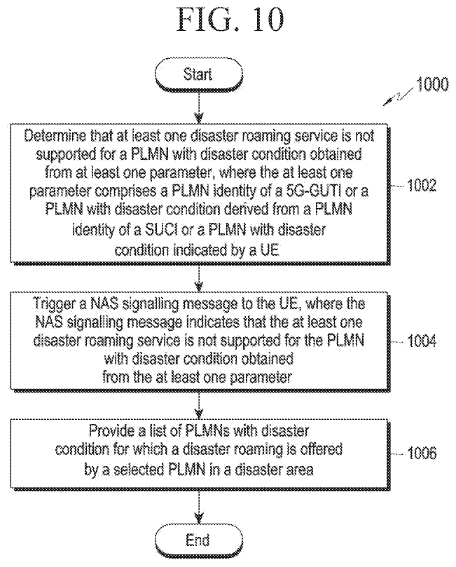

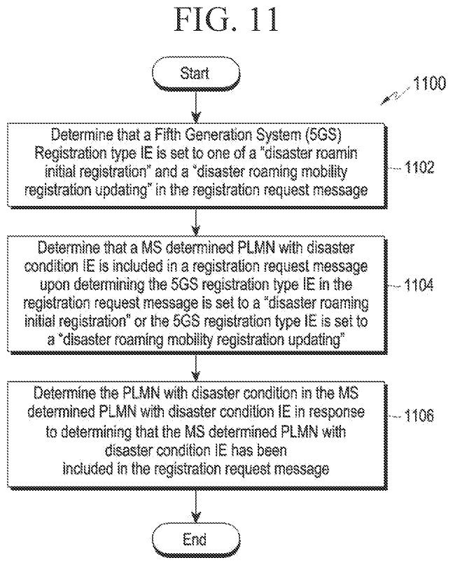

FIG. 8 to FIG. 11 are flow charts (800-1100) illustrating methods for determining the PLMN with the disaster situation in the wireless network (300), according to the embodiments as disclosed herein.

As shown in FIG. 8, the operations (802-812) are handled by the disaster situation handling controller (740). At 802, the method includes determining that the UE (100) is registering for the disaster roaming service and sets Fifth Generation System (5GS) Registration type IE to at least one of the “disaster roaming initial registration” and the “disaster roaming mobility registration updating” in the Registration Request message. At 804, the method includes determining whether the MS determined PLMN with disaster condition IE is included in the registration request message. Upon determining that the MS determined PLMN with disaster condition IE has not been included in the registration request message, at 812, the method includes determining the PLMN with disaster condition obtained from the PLMN identity of one of the 5G-GUTI or the SUCI, if the 5G-GUTI or the SUCI is included in any of the IE in the registration request message and is valid.

Upon determining that the MS determined PLMN with disaster condition IE has been included in the registration request message, at 806, the method includes determining that the MS determined PLMN with disaster condition IE is a “PLMN with disaster condition” for which the UE (100) is requesting at least one disaster roaming service. At 808, the method includes determining whether the at least one disaster roaming service need to be provided to the UE (100) for the “PLMN with disaster condition”. At 810, the method includes ignoring a PLMN with disaster condition derived from a PLMN identity of one of the 5G-GUTI or the SUCI, if the 5G-GUTI or the SUCI is included in any of the IE in the registration request message.

As shown in FIG. 9, the operations (902-906) are handled by the disaster situation handling controller (740). At 902, the method includes receiving the registration request message comprising the MS determined PLMN with disaster condition IE and at least one of the 5G-GUTI and the SUCI. At 904, the method includes determining that the “PLMN with disaster condition” derived from the PLMN identity of at least one of the 5G-GUTI and the SUCI is different from the “PLMN with disaster condition” indicated by the MS determined PLMN with disaster condition IE in the registration request message. At 906, the method includes considering the “PLMN with disaster condition” indicated by the MS determined PLMN with disaster condition IE as the PLMN with disaster condition for which the UE (100) is requesting at least one disaster roaming service and ignoring a PLMN with disaster condition derived from PLMN identity of at least one of the 5G-GUTI and the SUCI, if the 5G-GUTI or the SUCI is included in any of the IE in the registration request message and is valid based on the determination.

As shown in FIG. 10, the operations (1002-1006) are handled by the disaster situation handling controller (740). At 1002, the method includes determining that at least one disaster roaming service is not supported for the PLMN with disaster condition obtained from the at least one parameter. The at least one parameter includes the PLMN identity of the 5G-GUTI or the PLMN with disaster condition derived from the PLMN identity of the SUCI or the PLMN with disaster condition indicated by the UE (100). At 1004, the method includes triggering the NAS signalling message to the UE (100). The NAS signalling message indicates that the at least one disaster roaming service is not supported for the PLMN with disaster condition obtained from the at least one parameter. At 1006, the method includes providing the list of PLMNs with disaster condition for which the disaster roaming is offered by the selected PLMN in the disaster area.

As shown in FIG. 11, the operations (1102-1106) are handled by the disaster situation handling controller (740). At 1102, the method includes determining that a Fifth Generation System (5GS) Registration type information element (IE) is set to one of a “disaster roaming initial registration” and a “disaster roaming mobility registration updating” in the Registration Request message. At 1104, the method includes determining that the MS determined PLMN with disaster condition IE is included in the registration request message upon determining the 5GS registration type IE in the registration request message is set to the “disaster roaming initial registration” or the 5GS registration type IE is set to the “disaster roaming mobility registration updating”. At 1106, the method includes determining the PLMN with disaster condition in the MS determined PLMN with disaster condition IE in response to determining that the MS determined PLMN with disaster condition IE has been included in the registration request message.

The various actions, acts, blocks, steps, or the like in the flow charts (800 to 1100) may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

1. A method for determining a Public Land Mobile Network, PLMN, with disaster condition by an Access and Mobility Management Function, AMF, in a wireless network, comprising:
receiving a registration request message from a user equipment, UE;
identifying that a Fifth Generation System, 5GS, registration type information element, IE, in the registration request message is set to a “disaster roaming initial registration” or a “disaster roaming mobility registration updating”;
identifying whether a PLMN with disaster condition IE is included in the registration request message based on identifying that the 5GS registration type IE in the registration request message is set to the “disaster roaming initial registration” or the “disaster roaming mobility registration updating”; and
determining a PLMN with disaster condition in the PLMN with disaster condition IE based on identifying that the PLMN with disaster condition IE is included in the registration request message.

2. The method of claim 1, further comprising:
based on identifying that the PLMN with disaster condition IE is not included in the registration request message, determining the PLMN with disaster condition in a PLMN identity of a fifth generation-Globally Unique Temporary Identifier, 5G-GUTI, if an additional GUTI IE is included in the registration request message, and the additional GUTI IE contains the 5G-GUTI.

3. The method of claim 1, wherein the registration request message comprising the PLMN with disaster condition IE is received while the UE is registering for the disaster roaming service.

4. An apparatus of an Access and Mobility Management Function, AMF, for determining a Public Land Mobile Network, PLMN, with disaster condition in a wireless network, comprising:
a memory; and
at least one processor coupled to the memory, wherein the processor is configured to:
receive a registration request message from a user equipment, UE;
identify that a Fifth Generation System, 5GS, registration type information element, IE, in the registration request message is set to a “disaster roaming initial registration” or a “disaster roaming mobility registration updating”;
identify whether a PLMN with disaster condition IE is included in the registration request message based on identifying that the 5GS registration type IE in the registration request message is set to the “disaster roaming initial registration” or the “disaster roaming mobility registration updating”; and
determine a PLMN with disaster condition in the PLMN with disaster condition IE based on identifying that the PLMN with disaster condition IE is included in the registration request message.

5. The apparatus of claim 4, wherein the at least one processor is further configured to:
based on identifying that the PLMN with disaster condition IE is not included in the registration request message, determine the PLMN with disaster condition in a PLMN identity of a fifth generation-Globally Unique Temporary Identifier, 5G-GUTI, if an additional GUTI IE is included in the registration request message, and the additional GUTI IE contains the 5G-GUTI.

6. The apparatus of claim 4, wherein the registration request message comprising the PLMN with disaster condition IE is received while the UE is registering for the disaster roaming service.

7. A non-transitory computer readable storage medium storing instructions which, when executed by at least one processor of an apparatus of an Access and Mobility Management Function, AMF, in a wireless network, cause the apparatus perform operations, the operations comprising:
receiving a registration request message from a user equipment, UE;
identifying that a Fifth Generation System, 5GS, registration type information element, IE, in the registration request message is set to a “disaster roaming initial registration” or a “disaster roaming mobility registration updating”;
identifying whether a PLMN with disaster condition IE is included in the registration request message based on identifying that the 5GS registration type IE in the registration request message is set to the “disaster roaming initial registration” or the “disaster roaming mobility registration updating”; and
determining a PLMN with disaster condition in the PLMN with disaster condition IE based on identifying that the PLMN with disaster condition IE is included in the registration request message.

8. The non-transitory computer readable storage medium of claim 7,
wherein the operations further comprising:
based on identifying that the PLMN with disaster condition IE is not included in the registration request message, determining the PLMN with disaster condition in a PLMN identity of a fifth generation-Globally Unique Temporary Identifier, 5G-GUTI, if an additional GUTI IE is included in the registration request message, and the additional GUTI IE contains the 5G-GUTI.

9. The non-transitory computer readable storage medium of claim 7, wherein the registration request message comprising the PLMN with disaster condition IE is received while the UE is registering for the disaster roaming service.
